(19) United States
(12) Patent Application Publication
(10) Pub. No.: US 2025/0323991 A1
(43) Pub. Date: Oct. 16, 2025

(54) DATA TRANSMISSION METHOD, APPARATUS, DEVICE, AND STORAGE MEDIUM

(71) Applicant: GUANGDONG OPPO MOBILE TELECOMMUNICATIONS CORP., LTD., Dongguan, Guangdong (CN)

(72) Inventor: Hua GUO, Dongguan, Guangdong (CN)

(73) Assignee: GUANGDONG OPPO MOBILE TELECOMMUNICATIONS CORP., LTD., Dongguan, Guangdong (CN)

(21) Appl. No.: 18/870,236

(22) PCT Filed: Mar. 21, 2022
(86) PCT No.: PCT/CN2022/082053

§ 371 Date: Nov. 27, 2024

(30) Foreign Application Priority Data
Apr. 14, 2021 (CN) 202110401922.3

(51) Int. Cl. H04M 1/72412; G06F 1/3293

(52) U.S. Cl. CPC H04M 1/72412; G06F 1/3293

(57) ABSTRACT

A data transmission method and apparatus, a device, and a storage medium, relating to the field of wearable devices. The method comprises: receiving first communication data sent by a terminal, the first communication data being transmitted by means of a data communication connection established between a first system and the terminal (301); processing the first communication data by means of target middleware to obtain service data comprised in the first communication data, the target middleware being middleware configured in the first system (302); and sending the service data to a target application by means of the target middleware such that the target application processes the service data, the target application being an application in the first system or a second system (303).

The present application claims the priority of the Chinese patent application No. 202110401922.3, filed on Apr. 14, 2021, in the title of “DATA TRANSMISSION METHOD, APPARATUS, DEVICE, AND STORAGE MEDIUM”, contents of which are incorporated herein by its entireties.

### TECHNICAL FIELD

Embodiments of the present disclosure relate to the technical field of wearable devices, and more specifically, to a data transmission method, an apparatus, a device, and a storage medium.

### BACKGROUND

A wearable device is a portable electronic device that can be directly worn to or integrated into clothes or accessories, and common wearable devices include a smart watch, a smart bracelet, smart glasses, and so on.

In the related art, the wearable device establishes communication connection (such as Bluetooth connection) with a terminal, so as to transmit data with the terminal through the Bluetooth connection, such that interaction between the wearable device and the terminal is achieved. For example, the terminal may send a notification message to the wearable device via the Bluetooth connection, and the wearable device may perform notification and reminding.

### SUMMARY

The present disclosure provides a data transmission method, an apparatus, a device, and a storage medium.

In an aspect, the present disclosure provides a data transmission method, performed by a wearable device, wherein the wearable device comprises a first system and a second system, the first system is run by a first processor, the second system is run by a second processor.

The method includes:
receiving first communication data sent by a terminal, wherein the first communication data are transmitted through data communication connection established between the first system and the terminal;
processing the first communication data through a target middleware to obtain business data contained in the first communication data, wherein the target middleware is a middleware configured in the first system; and
sending the business data to a target application via the target middleware; processing, by the target application, the business data, wherein the target application is an application in the first system or an application in the second system.

In another aspect, the present disclosure provides a data transmission apparatus, arranged in a wearable device. The wearable device comprises a first system and a second system, the first system is run by a first processor, the second system is run by a second processor.

The apparatus includes:
a communication data receiving module, configured to receive first communication data sent by a terminal, wherein the first communication data are transmitted through data communication connection established between the first system and the terminal;
a communication data processing module, configured to process the first communication data through a target middleware to obtain business data contained in the first communication data, wherein the target middleware is a middleware configured in the first system;
a business data sending module, configured to send, via the target middleware, the business data to a target application to be processed by the target application, wherein the target application is an application in the first system or an application in the second system.

In another aspect, the present disclosure provides a wearable device, including a processor and a memory. The processor includes at least a first processor and a second processor, power consumption of the second processor is higher than power consumption of the first processor, the memory stores at least one instruction, the at least one instruction is configured to be executed by the processor to implement the data transmission method in the above aspect.

In another aspect, the present disclosure provides a computer-readable storage medium, storing at least one instruction. The at least one instruction is configured to be executed by a processor to implement the data transmission method in the above aspect.

In another aspect, the present disclosure provides a computer program product, comprising computer instructions, wherein the computer instructions are stored in a computer-readable storage medium; a processor of a computer device is configured to read the computer instructions from the computer-readable storage medium, the processor is configured to execute the computer instructions to cause the computer device to perform the data transmission method in the above aspect.

### BRIEF DESCRIPTION OF THE DRAWINGS

FIG. 1 is a schematic diagram of a framework of a second processor corresponding to dual-core communication software according to an embodiment of the present disclosure.

FIG. 2 is a schematic diagram of a framework of a first processor corresponding to dual-core communication software according to an embodiment of the present disclosure.

FIG. 3 is a flow chart of a data transmission method according to an embodiment of the present disclosure.

FIG. 4 is a schematic view of an interface during performing the data transmission method according to an embodiment of the present disclosure.

FIG. 5 is a flow chart of a data transmission method according to another embodiment of the present disclosure.

FIG. 6 is a schematic view of a timing sequence during performing the data transmission method shown in FIG. 5.

FIG. 7 is a flow chart of a data transmission method according to still another embodiment of the present disclosure.

FIG. 8 is a schematic view of a timing sequence during performing the data transmission method shown in FIG. 7.

FIG. 9 is a flow chart of a data transmission method according to still another embodiment of the present disclosure.

FIG. 10 is a schematic view of a timing sequence during performing the data transmission method shown in FIG. 9.

FIG. 11 is a schematic diagram of a framework of a software to dual-core communication software according to an embodiment of the present disclosure.

FIG. 12 is a schematic diagram of a data transmission apparatus according to another embodiment of the present disclosure.

FIG. 13 is a schematic diagram of a wearable device according to an embodiment of the present disclosure.

### DETAILED DESCRIPTIONS

In order to make the purposes, technical solutions and advantages of the present disclosure clearer, embodiments of the present disclosure will be described in further detail by referring to the accompanying drawings.

A term “a plurality of” in the present disclosure refers to two or more than two. A term “and/or” describes an association relationship of associated objects and indicates that three types of relationships may exist. For example, A and/or B may indicate that A is present alone, both A and B are present, and B is present alone. The character “/” generally indicates an object before the character “or” an object after the character.

In the related art, the wearable device is arranged with a single processor. The single processor runs an operating system to process all system events generated during the wearable device being operating. In addition, in order to achieve data linkage between the wearable device and a terminal, a communication module (such as a Bluetooth module) of the wearable device needs to be loaded on the processor, such that data received by the communication module is sent in real time to the operating system to be processed and responded by the operating system. Further, the wearable device may feedback a data processing result to the terminal through the communication module, such that mutual linkage between the terminal and the wearable device is achieved. Therefore, in order to ensure business data to be normally transmitted and timely responded, the processor needs to have a powerful data processing capability and needs to be maintained at an operating state at the time when the wearable device is operating.

However, for daily use, the wearable device in most cases only needs to achieve some functions that require low processing performance, or to achieve some simple linkage with the terminal. For example, a smartwatch or a smart bracelet, in most cases, only needs to display time or to display a notification message sent by the terminal. Therefore, enabling the processor to maintain at the operating state for a long period of time does not improve performance of the wearable device, but rather increases power consumption of the wearable device, and an endurance time of the wearable device may be decreased.

In embodiments of the present disclosure, the wearable device is configured with at least a first processor and a second processor having different processing performance and different power consumption. The first processor is configured to run a first system, and the second processor is configured to run a second system (i.e., dual cores and dual systems). In addition, the communication module of the wearable device is loaded on the first processor.

When the wearable device is operating, the first system on the processor having lower power consumption is run, events requiring low processing performance are processed, and the other processor having higher power consumption is kept in a dormant state (accordingly, the second system run by the other processor having higher power consumption is in the dormant state). In this way, while basic functions of the wearable device are achieved, power consumption of the wearable device is reduced.

Furthermore, since the first system is in the operating state, the wearable device can receive communication data sent by the terminal in real time through data communication connection established between the first system and the terminal can parse, through a middleware configured in the first system, the communication data to obtain the business data contained therein. Furthermore, the middleware configured in the first system distributes the business data to an application in the first system or an application in the second system based on processing requirements of the business data, ensuring the business data to be processed in time and achieving the linkage between the terminal and the wearable device.

When an event that requires high processing performance (such as when launching an application) occurs, the other processor having higher power consumption is awakened, and the second system is switched on to process the event to ensure that any triggered event can be responded to and processed in time, and performance requirements of the wearable device are satisfied.

In embodiments of the present disclosure, the first processor and the second processor operate asynchronously, and the first system and the second system need to perform system communication (also known as dual-core communication). In an application scenario, the first system is a Real Time Operating System (RTOS) running on a Micro Controller Unit (MCU), and the second system is the Android operating system running on a Central Processing Unit (CPU).

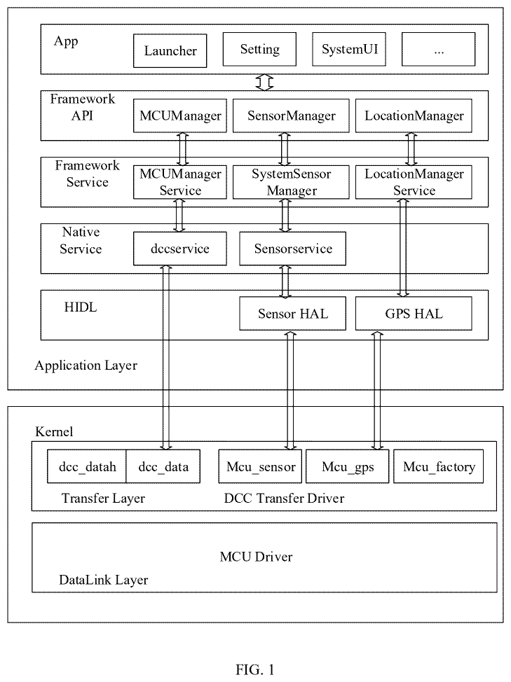

As shown in FIG. 1, a dual-core communication software framework for the Android operating system according to an embodiment of the present disclosure is shown. The dual-core communication software framework includes a kernel module, a hardware abstraction layer interface description language (HIDL) module, a native service module, a framework service module, a framework API module, and an application (APP) module.

The APP module includes functional modules, such as a launcher (desktop launcher) module, a setting and system user interface (system UI) module, and so on. The framework API module includes management modules, such as a MCU Manager module, a SensorManager module, a LocationManager module, and so on. The framework service module includes service modules, such as a MCUManagerService module, a System SensorManager module, a LocationManagerService module, and so on. The Native Service module includes service modules, such as a dccservice (dcc service) module, a Sensorservice module, and so on. The HIDL module includes modules, such as a Sensor HAL module, a GPS HAL module, and so on. The Kernel module includes dcc_datah, dcc_data, Mcu_sensor, Mcu_gps, Mcu_factory and other DCC Transfer Driver.

A transfer layer, serving as an interface layer connecting an upper layer and a lower layer in the dual-core communication software framework, shields transmission details of communication of the lower layer of the system (a data link layer) from an application layer, such that a service channel is provided for application scenarios. The application layer, serving as a subject of providing services, responds to human-computer interaction; transfers, through the transfer layer, data generated during the human-computer interaction; and responds to external data requests.

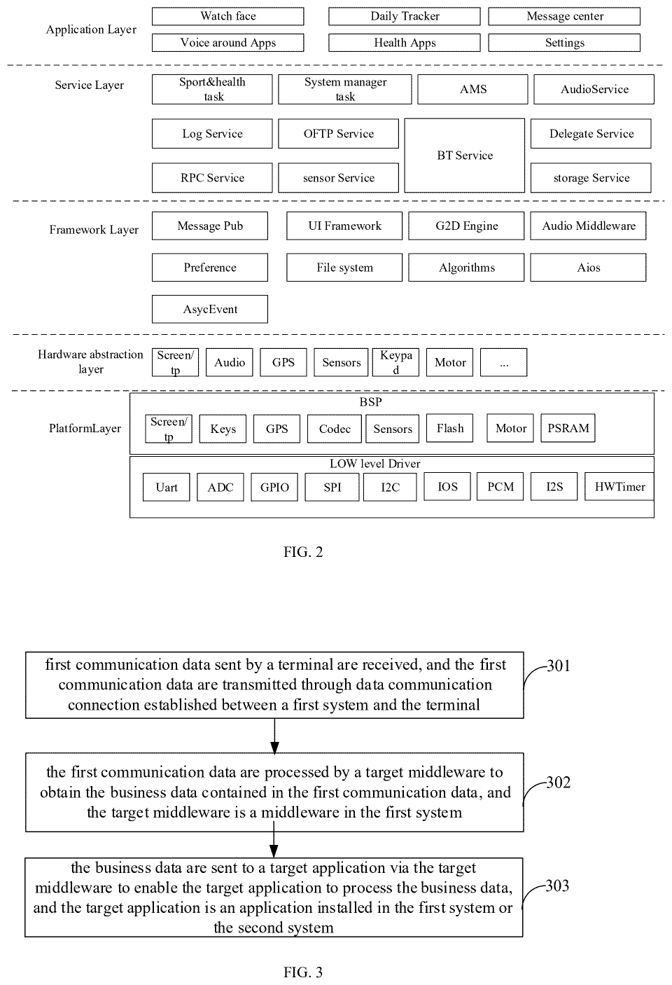

Taking the smartwatch as an example of the wearable device, FIG. 2 shows a dual-core communication software framework of RTOS according to an embodiment of the present disclosure.

The dual-core communication software framework of the RTOS includes an application layer, a service layer, a framework layer, a hardware abstraction layer and a platform layer.

The application layer includes a watch face module, a daily tracker module, a message center module, voice around applications module, health applications module, settings module and other application modules. The service layer includes service modules, such as a sport & health task module, a system manager task module, an activity management service (AMS) module, an AudioService module, a log service module, an OFTP service module, a Bluetooth (BT) Service module, a delegate service module, a remote provoking call (RPC) service module, a sensor service module, a storage service module, and so on. The framework layer includes framework modules, such as a Message Pub module, a user interface framework (UI framework) module, a G2D engine module, an Audio Middleware module, a Preference module, a File system module, an Algorithms module, an Aios module, an in-process asynchronous event (AsycEvent) module, and so on. The hardware abstraction layer includes hardware abstraction modules, such as a Screen/TP module, an Audio module, a GPS module, a sensors module, a Keypad module, a Motor module, and so on. The platform layer includes a board support package (BSP) and a LOW level Driver. The BSP includes Screen/TP, Keys, a GPS, a Codec, sensors, a Flash, a Motor, a PSRAM and so on. The LOW level Driver includes a Uart, an Analog to Digital Converter (ADC), general-purpose input/output (GPIO), a Serial Peripheral Interface (SPI), an Integrated Circuit Bus (I2C), an Input/Output System (IOS), Pulse Coded Modulation (PCM), an Integrated Audio Bus (I2S), a Hardware Timer (HWTimer).

It should be noted that the above dual-core communication software framework is for schematic illustration only. Any ordinary skilled person in the art may also perform addition, deletion or modification on the above framework according to the actual demands, and the present disclosure does not limit a specific structure of the dual-core communication software framework.

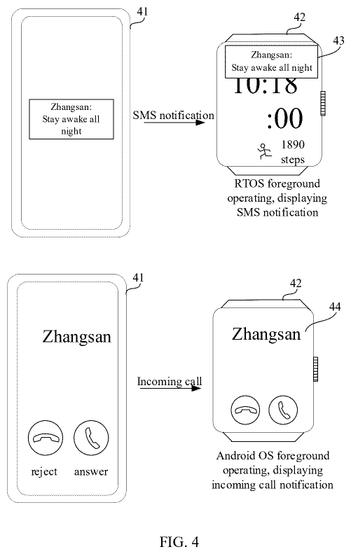

As shown in FIG. 3, FIG. 3 is a flow chart of a data transmission method according to an embodiment of the present disclosure. The present embodiment is illustrated by taking the wearable device as an example, and the method may include following operations.

In an operation 301, first communication data sent by a terminal are received, and the first communication data are transmitted through data communication connection established between a first system and the terminal.

In an embodiment, the wearable device is configured with a first processor and a second processor, the first processor is configured to run the first system, and the second processor is configured to run a second system. In some embodiments, processing performance of the first processor is lower than processing performance of the second processor (a processing capability and a processing speed of the first processor are lower than those of the second processor), and power consumption of the first processor is lower than power consumption of the second processor. Accordingly, the second system (operated by the second processor) can process events processed by the first system (run by the first processor), whereas the first system is not necessarily capable of processing events processed by the second system.

In a case that the wearable device is the smartwatch, the first processor is an MCU, the second processor is a CPU. The first system is an RTOS, and the second system is the Android operating system. Accordingly, the events that can be processed by the first system include displaying a watch face, switching an interface of the watch face, displaying a notification message, and other scenarios that require low processing performance or less interaction. The events that can be processed by the second system include answering an incoming call, launching an application, editing the watch face, function setting, and other scenarios that require high processing performance or strong interactions.

Unlike smartphones, which are electronic devices having strong interaction properties, the wearable device is an auxiliary electronic device and has weak interaction with a user in most cases. For example, in most scenarios, the user only lifts a wrist to check a time or a message prompt on the smartwatch. Therefore, during the wearable device operating, the first system maintains at an operating state, and the second system operates only in a scenario that requires high processing performance or strong interactions and remains in a dormant state in other scenarios.

Moreover, in order to ensure that the data sent by the terminal can be received and processed in time, in an embodiment, a communication module of the wearable device is loaded on the first processor. In this way, during the wearable device operating, the terminal and the first system can maintain the data communication connection, the wearable device maintains having low power consumption. To be noted that, when the second system is awakened and is in a foreground operating state (during which the first system is switched to a background operating state), the data communication connection between the first system and the terminal is still maintained. That is, during the wearable device operating, the wearable device transmits the communication data always through the data communication connection between the first system and the terminal.

In some embodiments, the data communication connection is Bluetooth connection, and the first processor communicates with a Bluetooth communication assembly via a physical serial port. The physical serial port may be a universal asynchronous receiver/transmitter (UART).

In some embodiments, when the terminal needs to send business data to the wearable device to be processed by the wearable device, i.e., the terminal packages the business data as the first communication data and sends the first communication data to the first system of the wearable device via the data communication connection. The first communication data may be obtained by an application program in the terminal (via a middleware SDK) invoking a middleware configured in the system to package the business data.

The middleware is a type of software configured between the operating system and the applications and is configured to connect the operating system layer to the application layer. By standardizing interfaces provided by the operating system and unifying protocols, standardized and unified public services are provided to upper-layer applications. In this way, a development workload of the upper-layer applications is reduced. The middleware in the present disclosure is configured to provide communication support for the first system and applications installed in the first system, or provide communication support for the second system and applications installed in the second system.

In an operation 302, the first communication data are processed by a target middleware to obtain the business data contained in the first communication data, and the target middleware is a middleware configured in the first system.

In an embodiment, the target middleware is configured in the first system, and no middleware is configured in the second system. The target middleware is configured to: uniformly process the data transmitted through the data communication connection to obtain the business data; distribute, based on processing requirements of the business data (i.e., the business data needs to be processed by which application in which system), the business data to an upper layer application in a corresponding system to be processed. That is, regardless of whether the communication data sent by the terminal need to be processed by the first system or the second system, the communication data always need to be processed by the target middleware in the first system.

In addition, the target middleware is further configured to process the data fed back by the upper layer application in the system into communication data to be reversely transmitted to the terminal through a communication assembly. In this way, bidirectional transmission of data between the terminal and the wearable device is achieved.

In some embodiments, after the wearable device receives the first communication data through the first system, the wearable device takes the target middleware to process the first communication data to obtain the business data. Before processing the first communication data through the middleware, the wearable device de-packages, through a communication protocol stack (such as a Bluetooth protocol stack) in the first system, the first communication data.

Since the target middleware is configured in the first system and the first system is always in an operating state (switched between foreground operating and background operating) during the wearable device operating, it is ensured that the communication data are processed in time, and low power consumption is maintained (if the middleware is configured in the second system, the second system needs to be woken up frequently, leading to an increase in power consumption).

In another embodiment, the second system is also configured with the middleware. However, the middleware in the second system does not operate during performing the data transmission method in the present disclosure, and the middleware in the second system is configured to achieve other functions. In order to provide convenient description, each of the following embodiments is illustrated as an example in which no middleware is configured in the second system, but these embodiments do not limit the present disclosure.

In an operation 303, the business data are sent to a target application via the target middleware to enable the target application to process the business data, and the target application is an application installed in the first system or the second system.

In an embodiment, the target middleware sends, based on the processing requirements of the business data, the business data to the target application in the first system in which the target middleware is configured, or, the target middleware forwards the business data to the target application in the system. That is, the target application and the target middleware may be configured in one same system or in different systems.

In an embodiment, the target application is configured with the middleware SDK, and the target middleware is invoked through the middleware SDK. In this way, data interaction with the target middleware is achieved.

In an embodiment, after processing the business data, the system in which the target application is installed displays a processing result.

In an example, as shown in FIG. 4, the terminal 41 sends the communication data containing an SMS notification to the wearable device 42. In a case that the RTOS is in the foreground operating state, the wearable device 42 displays the SMS notification 43 at an upper layer of the interface of the watch face of the RTOS. The terminal 41 sends communication data containing an incoming call notification to the wearable device 42, and in a case that the Android operating system is in the foreground operating state, the wearable device 42 displays the incoming call notification 44 via a calling application of the Android operating system.

In summary, in the present embodiment, the wearable device is configured with the dual processors, the first processor runs the first system, and the second processor runs the second system. After the first system receives the communication data sent by the terminal through the data communication connection established between the first system and the terminal, the middleware configured in the first system processes the communication data to obtain the business data contained in the communication data. The middleware sends the business data to the application in the first system or the second system to perform business processing. Since the wearable device maintains data communication with the terminal through the first system, an effect caused by system switching on the data communication can be avoided, stability of the data communication between the wearable device and the terminal is ensured. In addition, the middleware configured in the first system processes and distributes the data, ensuring that the business data in the first system and in the second system can be processed in time and improving a business responding speed at the wearable device.

In addition, in a case that the power consumption of the first processor is lower than that of the second processor, since the data communication connection is established between the first system having the lower power consumption and the terminal, the power consumption of the wearable device can be reduced and normal transmission of the data is ensured.

In some embodiments, the operation of sending the business data to the target applications via the target middleware, includes following operations.

A target system configured to process the business data is determined by the target middleware.

The target middleware sends the business data to a target application in the target system.

In some embodiments, the operation of sending the business data to the target application in the target system via the target middleware, includes following operations.

In a case that the target system is the first system, the target middleware sends the business data to the target application in the first system.

In a case that the target system is the second system, the target middleware sends the business data to a middleware proxy in the second system, and the middleware proxy sends the business data to the target application in the second system. In some embodiments, in the case that the target system is the second system, before the target middleware sending the business data to the middleware proxy in the second system, the method further includes following operations.

The second processor is switched from the dormant state to the wake-up state in a case that the first system is in the foreground operating state and the second system is in the dormant state.

In some embodiments, the operation of the target middleware sending the business data to the target application in the target system, further includes following operations.

In a case that the target system is the first system or the second system, the target middleware sends the business data to the target application in the target system that is in the foreground operating state.

In some embodiments, the operation of the target middleware sending the business data to the target application in the target system that is in the foreground operating state, includes following operations

The target middleware sends the business data to the target application in the first system in the case that the first system is in the foreground operating state.

In the case that the second system is in the foreground operating state, the target middleware sends the business data to the middleware proxy in the second system, and the middleware proxy sends the business data to the target application in the second system.

In some embodiments, after the target middleware sending the business data to the target application, the method further includes following operations.

The target middleware processes business response data of the target application to obtain second communication data.

The second communication data are sent to the terminal, such that the terminal processes the business response data, and the second communication data are transmitted through the data communication connection.

In some embodiments, the operation of the target middleware processing the business response data of the target application to obtain the second communication data, includes following operations.

In the case that the target application is the application in the second system, the middleware proxy in the second system obtains the business response data.

The middleware proxy sends the business response data to the target middleware.

The target middleware processes the business response data to obtain the second communication data.

In some embodiments, the data communication connection is Bluetooth connection, and the first processor communicates with the Bluetooth communication assembly via the physical serial port.

In some embodiments, the power consumption of the second processor is higher than the power consumption of the first processor.

In an embodiment, according to different data processing demands, the communication data sent from the terminal to the wearable device include following three types.

1. Data that are Uunique for the First System and can be Processed by Only the First System

The business data contained in this type of communication data are data that require low processing performance or require weak interactions. For this type of communication data, it is only needed to display the processing result through the first system.

2. Data that are Unique for the Second System and can be Processed by Only the Second System

The business data contained in this type of communication data are data that require high processing performance or require strong interactions. For this type of communication data, specific applications in the second system are needed to provide business responses and display the processing result. For example, communication data containing the incoming call notification require the calling application in the second system to perform incoming call notification.

3. Data that are Common for Both the First System and the Second System and can be Processed by Either One of the First System and the Second System

The business data contained in this type of communication data are data that require low processing performance or weak interactions and can may be processed by the first system or the second system depending on a foreground operation state of the system, and a processing result may be displayed. For example, for the communication data containing the SMS notification, an SMS notification banner is displayed by the system that is in the foreground operating state.

Of course, since functions to be achieved by the first system are usually a subset of functions to be achieved by the second system, in other embodiments, the communication data may include two types (i.e., the type 2 and the type 3 in the above), which are not limited by the present disclosure.

In order to ensure that, after the target middleware distributes the business data, the system receiving the business data can correctly process the business data through the application. In an embodiment, the target middleware has a function of determining a target system corresponding to the business data, and the target system is configured to process the business data.

In some embodiments, the target middleware is configured to identify: data unique to the first system, data unique to the second system, and data common to the first system and the second system; or is configured to identify the data unique to the second system and the data common to the first system and the second system. The present disclosure does not limit a specific business data identification capability of the target middleware.

Accordingly, after the wearable device obtains the business data by taking the target middleware to process the communication data, the wearable device determines the target system for processing the business data, and the target middleware sends the business data to the target application in the target system.

Processes of distributing the business data for the above three types of processing requirements will be described below based on embodiments.

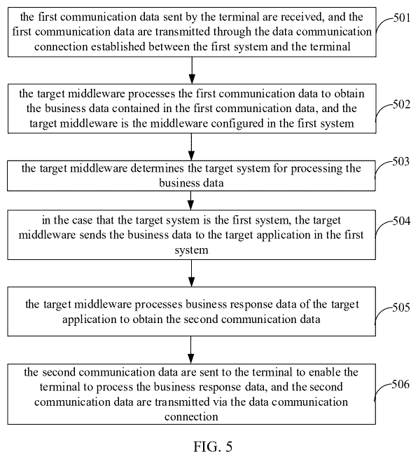

As shown in FIG. 5, FIG. 5 shows a flow chart of the data transmission method according to another embodiment of the present disclosure. The method of the present embodiment is illustrated by taking the wearable device as an example, and the method includes following operations.

In an operation 501, the first communication data sent by the terminal are received, and the first communication data are transmitted through the data communication connection established between the first system and the terminal.

In an operation 502, the target middleware processes the first communication data to obtain the business data contained in the first communication data, and the target middleware is the middleware configured in the first system.

The operations 501 and 502 can be referred to the operations 301 and 302 in the above, and will not be repeated herein.

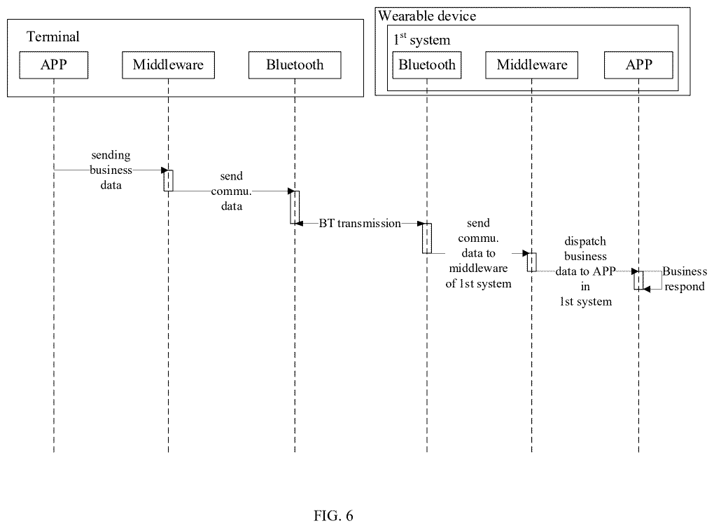

Exemplarily, as shown in FIG. 6, in an example, the Bluetooth communication is performed between the terminal and the wearable device. After an application in the terminal generates the business data, the terminal firstly sends the business data to the middleware. After the middleware processes the business data into the communication data, the middleware sends the communication data to the Bluetooth module, such that the communication data are transmitted to the Bluetooth module of the first system through the Bluetooth connection. After receiving the communication data through the Bluetooth connection, the first system sends the communication data to the middleware in the first system to be processed by the middleware in the first system to obtain the business data.

In an operation 503, the target middleware determines the target system for processing the business data.

In an embodiment, correspondence between the business data and systems is configured in advance in the target middleware. After processing the first communication data to obtain the business data, the target middleware determines, from the correspondence, the target system for processing the business data.

Exemplarily, the correspondence between the business data and the systems is shown in Table 1.

TABLE 1

| System | Business data |
|---|---|
| First system | Business A |
| Second system | Business B, Business C, Business D, |
| | Business E |
| First system/second system | Business F, Business G |

In some embodiments, the target middleware may determine the target system from the above correspondence based on an application package name and/or an activity name corresponding to the business data.

For example, when the business data obtained by processing the communication data correspond to the Business A, the target middleware identifies the first system as the target system.

In an operation 504, in the case that the target system is the first system, the target middleware sends the business data to the target application in the first system.

When the target system is the first system, since the target middleware is configured in the first system, the wearable device can directly send, via the target middleware, the business data to the target application in the first system, and the target application processes the business data.

In some embodiments, during the target application processing the data, the first system displays the processing result, such that the user is notified on the wearable device.

Exemplarily, as shown in FIG. 6, the middleware of the first system distributes the business data, obtained after processing the communication data, to the application in the first system, and the application performs business responding.

In an operation 505, the target middleware processes business response data of the target application to obtain the second communication data.

In an embodiment, the target application processes the business data to generate the business response data. The business response data may be generated based on user interaction or automatically generated during the application processing the data. When the business response data needs to be fed back to the terminal, the target application processes the business response data through the target middleware to obtain the second communication data. In the present embodiment, the target application processes the business response data through the first middleware to obtain the second communication data. A process of processing the business response data to obtain the second communication data can be interpreted as a reverse process of processing the first communication data to obtain the business data.

In some embodiments, the middleware SDK is configured in the target application. When the business response data needs to be transmitted to the terminal, the target application namely invokes the target middleware through the middleware SDK, and the target middleware processes the business response data.

In an operation 506, the second communication data are sent to the terminal to enable the terminal to process the business response data, and the second communication data are transmitted via the data communication connection.

Further, the wearable device (the first system) sends the second communication data to the terminal via the data communication connection. Accordingly, after the terminal receives the second communication data via the data communication connection, the terminal processes, via the middleware, the second communication data to obtain business response data; and distributes the business response data to a corresponding application in the terminal.

Before sending the second communication data to the terminal, the wearable device performs, through a communication protocol stack in the first system, protocol packaging on the second communication data to enable the second communication data to satisfy a communication transmission protocol. The communication assembly sends the protocol-packaged second communication data.

In the present embodiment, when the target middleware recognizes that the business data are to be processed by the first system, the business data obtained after processing are distributed to the application in the first system to be processed. In this way, timeliness and accuracy of processing the business data by the first system are improved, and the second system remains in the dormant state during the entire process, such that the power consumption of the terminal is reduced.

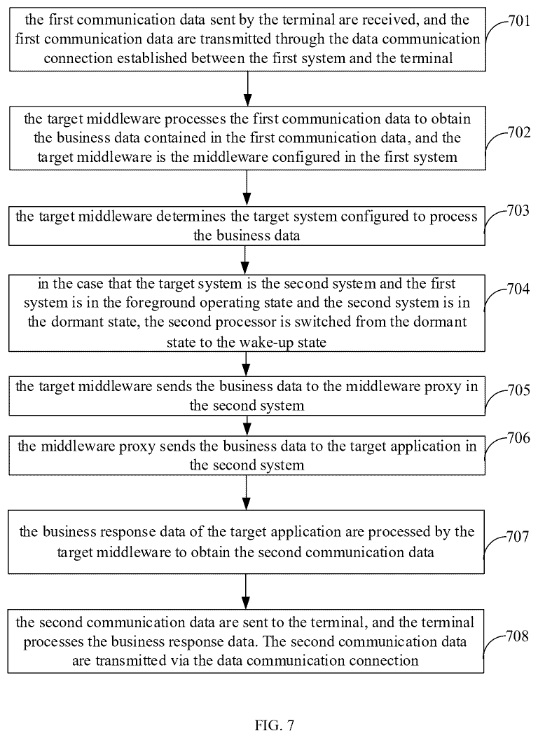

As shown in FIG. 7, FIG. 7 is a flow chart of the data transmission method according to still another embodiment of the present disclosure. The method of the present embodiment is illustrated by taking the wearable device as an example, and the method includes following operations.

In an operation 701, the first communication data sent by the terminal are received, and the first communication data are transmitted through the data communication connection established between the first system and the terminal.

In an operation 702, the target middleware processes the first communication data to obtain the business data contained in the first communication data, and the target middleware is the middleware configured in the first system.

The operations 701 to 702 can be referred to the operations 301 to 302 in the above, and will not be repeated herein.

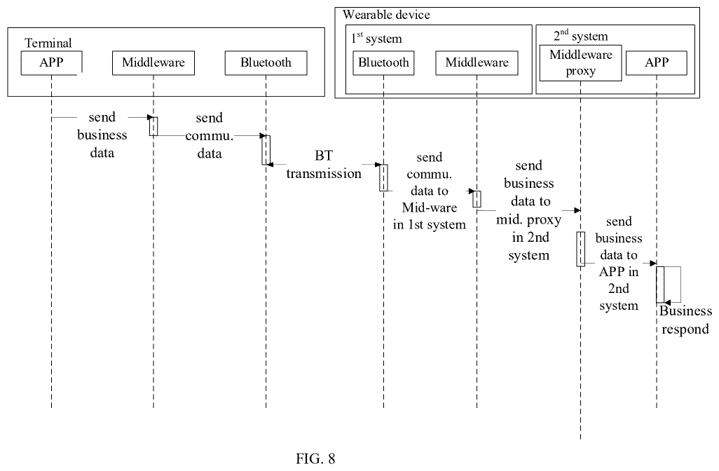

Exemplarily, as shown in FIG. 8, taking the Bluetooth communication between the terminal and the wearable device as an example, after the application in the terminal generates the business data, the terminal firstly sends the business data to the middleware. After the middleware processes the business data into the communication data, the middleware sends the communication data to the Bluetooth module, so as to transmit the communication data to the Bluetooth module of the first system via the Bluetooth connection. After receiving the communication data via the Bluetooth connection, the first system sends the communication data to the middleware in the first system, the middleware in the first system processes the communication data to obtain the business data.

In an operation 703, the target middleware determines the target system configured to process the business data.

Implementation of the present operation may be referred to the operation 503 above, and will not be repeated herein.

In an embodiment, when the wearable device receives the first communication data, the second system may be in the dormant state, and the second system in the dormant state cannot process the business data. Therefore, when the second system is determined as the target system configured to process the business data, the wearable device needs to detect whether the second system (i.e., the second processor) is in the foreground operating state. In the case that the second system is in the foreground operating state, an operation 705 is performed. In the case that the second system is in the dormant state, an operation 704 is performed.

In the operation 704, in the case that the target system is the second system and the first system is in the foreground operating state and the second system is in the dormant state, the second processor is switched from the dormant state to the wake-up state.

In an embodiment, in the case that the second processor is in the dormant state (when the first system is in the foreground operating state), the first processor wakes up the second processor by generating an interrupt, and the second processor receives the interrupt and switches from the dormant state to the wake-up state.

In some embodiments, the second system is in the foreground operating state after being woken up, and the first system is switched to the background operating state; or, the second system is in the background operating state after being woken up, and the first system remains in the foreground operating state.

In the operation 705, the target middleware sends the business data to the middleware proxy in the second system.

In the embodiment of the present application, since the middleware is configured only in the first system, in order to enable the application in the second system to correctly receive the business data, the middleware proxy corresponding to the target middleware in the first system is configured in the second system. The middleware proxy serves as a data communication medium between the target middleware and the application in the second system, and has only a function of data forwarding. The middleware proxy cannot process the business data.

Accordingly, in the case that the target system is the second system, the wearable device sends, through the target middleware, the business data obtained from the processing to the middleware proxy in the second system. The middleware proxy forwards the business data to the upper layer application. In some embodiments, the target middleware sends the business data to the middleware proxy via a UART between the first system and the second system.

Exemplarily, as shown in FIG. 8, when the business data can only be processed by the application in the second system, the middleware in the first system sends the business data to the middleware proxy in the second system.

In an operation 706, the middleware proxy sends the business data to the target application in the second system.

Further, the middleware proxy forwards the received business data to the target application in the second system, and the target application processes and responds to the business data.

Exemplarily, as shown in FIG. 8, the middleware proxy forwards the business data to the application in the second system, the target application performs the business responding.

In an operation 707, the business response data of the target application are processed by the target middleware to obtain the second communication data.

The target application generates the business response data after processing the business data. The business response data are generated based on user interaction or automatically generated during the application processing the data. For example, when the business data is the incoming call notification, after the calling application displays the incoming call notification on the interface, the user can perform an answering operation or a rejection operation on the interface. The answering operation or the rejection operation generates the business response data correspondingly.

When the business response data needs to be fed back to the terminal (for example, an answering instruction or a rejection instruction needs to be fed back to the terminal), the target application processes the business response data through the target middleware to obtain the second communication data that meets the transmission requirements of the communication connection.

In the present embodiment, since no middleware is configured in the second system and the second system does not establish the data communication connection with the terminal, the target application in the second system needs to forward the business response data to the target middleware in the first system, and the target middleware processes the business response data in order to perform data transmission subsequently.

In an embodiment, in the case that the target application is the application in the second system, the wearable device obtains, through the middleware proxy in the second system, the business response data generated by the target application. The middleware proxy sends the business response data to the target middleware, such that the middleware processes the business response data to obtain the second communication data.

In an example, when the business data is an incoming call notification and the business response data is an answering instruction, the calling application in the second system sends the answering instruction to the middleware proxy by invoking the middleware SDK. The middleware proxy forwards the answering instruction to the middleware in the first system. After receiving the answering instruction, the middleware processes the answering instruction to obtain the second communication data.

In an operation 708, the second communication data are sent to the terminal, and the terminal processes the business response data. The second communication data are transmitted via the data communication connection.

Since the wearable device establishes the data communication connection with the terminal only through the first system, the wearable device further sends the second communication data to the terminal through the data communication connection.

To be noted that, the first system needs to process (protocol packaging) the second communication data through a communication protocol stack before sending the second communication data to the terminal and sends the processed second communication data to the terminal. For example, the first system firstly processes the second communication data through the Bluetooth protocol stack, and then sends the processed second communication data to the terminal.

In the present embodiment, when the target middleware determines that the business data are to be processed by the second system, the target middleware sends the business data obtained after processing to the middleware proxy in the second system, and the middleware proxy forwards the business data to the application in the second system, ensuring the second system to respond to the business data in time. In addition, by configuring the middleware proxy, the second system does not need to be configured with the middleware, such that complexity of the second system is reduced.

As shown in FIG. 9, FIG. 9 shows a flow chart of the data transmission method according to another embodiment of the present disclosure. The method of the present embodiment is illustrated by taking the wearable device as an example, and the method includes following operations.

In an operation 901, the first communication data sent by the terminal are received, the first communication data are transmitted through the data communication connection established between the first system and the terminal.

In an operation 902, the target middleware processes the first communication data to obtain the business data contained in the first communication data, and the target middleware is the middleware configured in the first system.

Implementation of the operations 901 and 902 can be referred to the operations 301 and 302 in the above, and will not be repeated herein.

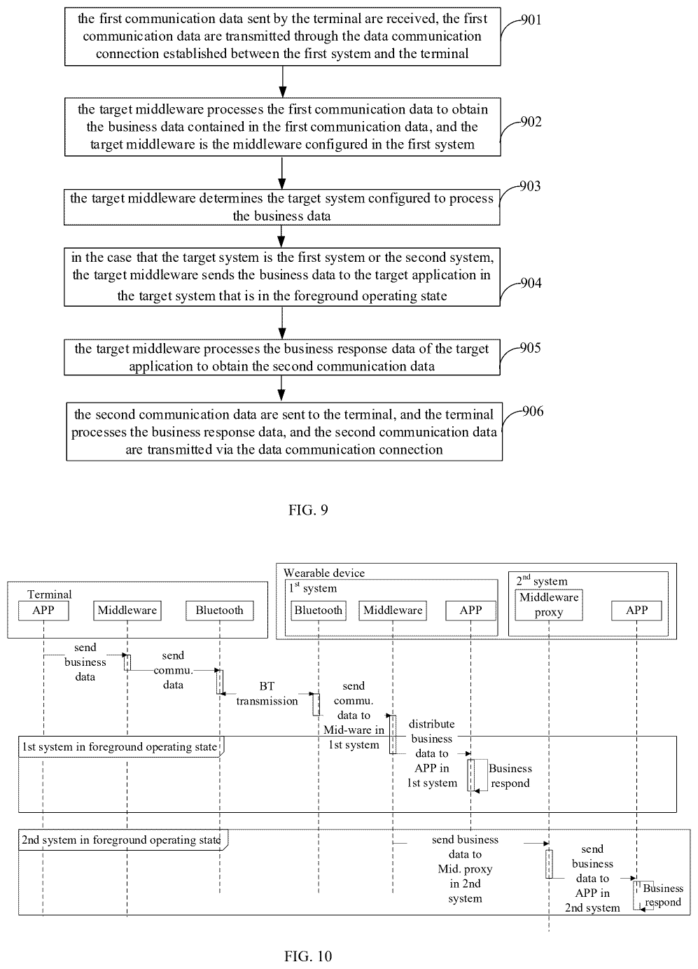

Exemplarily, as shown in FIG. 10, taking the Bluetooth communication between the terminal and the wearable device as an example, after the application in the terminal generates the business data, the terminal firstly sends the business data to the middleware. After the middleware processes the business data into the communication data, the middleware sends the communication data to the Bluetooth module, such that the communication data are sent to the Bluetooth module of the first system via the Bluetooth connection. After the first system receives the communication data via the Bluetooth connection, the first system sends the communication data to the middleware in the first system, and the first system processes the communication data to obtain the business data.

In an operation 903, the target middleware determines the target system configured to process the business data.

Implementation of the present operation can be referred to the operation 503 above, and will not be repeated herein.

In an operation 904, in the case that the target system is the first system or the second system, the target middleware sends the business data to the target application in the target system that is in the foreground operating state.

Since only one system has a control authority over the graphical user interface of the wearable device at a certain time point (i.e., a display of the wearable device can be used by only one system at the certain time point), for the data common to the first system and the second system, the wearable device determines, based on the system operation state of the dual systems, the system currently in the foreground operating state as the system configured to process the business data, and the target application in the system currently in the foreground operating state responds to and processes the business data.

In some embodiments, in the case that the first system is in the foreground operating state, the wearable device sends the business data to the target application in the first system via the target middleware.

In the case that the second system is in the foreground operation state, the wearable device sends the business data to the middleware proxy in the second system via the target middleware, and the middleware proxy sends the business data to the target application in the second system. Descriptions of the middleware proxy can be referred to the above embodiments, and will not be repeated herein.

Exemplarily, as shown in FIG. 10, in the case that the first system is detected as being in the foreground operating state and the second system is in the dormant state, the middleware in the first system distributes the business data to the application in the first system, and the application in the first system performs the business processing and responding. In the case that the second system is detected as being in the foreground operating state and the first system is detected as being in the background operating state, the middleware in the first system sends the business data to the middleware proxy in the second system, the middleware proxy further forwards the business data to the application in the second system, and the application in the second system ultimately performs the business processing and responding.

In other embodiments, the target middleware may alternatively firstly send the business data to the first application in the first system. In a case of detecting that the second system is in the foreground operating state, the application in the first system sends the business data to the second application in the second system (i.e., the target application). The first application may send the business data to the second application via a physical serial port between the first system and the second system. For example, the physical serial port may be a Serial Peripheral Interface (SPI).

In some embodiments, in a case of detecting that the system in the foreground operating state is switched from the first system to the second system within a predetermined time length, in order to avoid service omission due to rapid switching between systems, after the target middleware sends the business data to the application in the first system, the target middleware may send again the business data to the application in the second system, such that the application in the second system processes and displays the business data.

In an operation 905, the target middleware processes the business response data of the target application to obtain the second communication data.

In an embodiment, when the target application and the target middleware are installed in a same system (i.e., the application in the first system), the target application sends the business response data directly to the target middleware. When the target application and the target middleware are installed in different systems (i.e., the application in the second system), the target application sends the business response data to the target middleware through the middleware proxy.

In other embodiments, when the target application and the target middleware are installed in different systems, the target application may alternatively forward the business response data to the target middleware through the application in the first system (the system that processes the business data may be the first system or the second system), which will not be repeated herein.

In an operation 906, the second communication data are sent to the terminal, and the terminal processes the business response data, and the second communication data are transmitted via the data communication connection.

Implementation of the present operation may refer to the operation 708 above, and will not be described herein.

In the present embodiment, when the target middleware identifies that the business data can be processed by the first system or the second system, the target middleware sends the business data obtained after processing to the application in the system that is in the foreground operating state, and the system that is in the foreground operating state responds to the business in time, such that timeliness of the business responding is improved.

In combination with the above embodiments, in an example, when communication between the terminal and the wearable device is achieved via the Bluetooth (BT) connection, a software framework of the terminal and the wearable device is shown in FIG. 11.

An application is installed in the terminal 1110, and the application is configured with a middleware SDK. The application sends, through the middleware SDK, data to a BT API, such that the terminal sends the data to other devices via BT or the application obtains data received by the terminal via BT.

The wearable device 1120 is configured with the first system 1121 and the second system 1122. The first system 1121 communicates with the terminal 1110 via the Bluetooth connection (each of the terminal 1110 and the first system 1121 is configured with a respective BT stack, and the second system is not configured with the BT stack), and the first system 1121 and the second system 1122 communicate with each other via the physical serial port (the SPI and the UART).

When the terminal 1110 sends the data unique for the first system to the wearable device 1120 via the Bluetooth connection, the first system processes the data via the target middleware and distributes the business data, obtained after the processing, to the application in the first system, and the first system performs the business responding.

When the terminal 1110 sends the data common to the first system and the second system to the wearable device 1120 via the Bluetooth connection, the first system processes the data via the target middleware and distributes the business data, obtained after the processing, to the application in the first system or the application the second system based on the foreground operation state of the first system 1121 and the foreground operation state of the second system 1122. In the case that the first system 1121 is in the foreground operating state, the first system 1121 distributes the business data to the application in the first system. In the case that the second system 1122 is in the foreground operating state, the first system sends the business data via the middleware to the middleware proxy (via the UART), the middleware proxy forwards the business data to the application in the second system; alternatively, the application in the first system forwards the business data to the application in the second system (via the SPI).

When the terminal 1110 sends the data unique for the second system to the wearable device 1120 via the Bluetooth connection, the first system 1121 sends, through the UART, the business data obtained by being processed by the middleware to the middleware proxy of the second system 1122, the middleware proxy forwards the business data to the application in the second system, and the application in the second system performs the business responding.

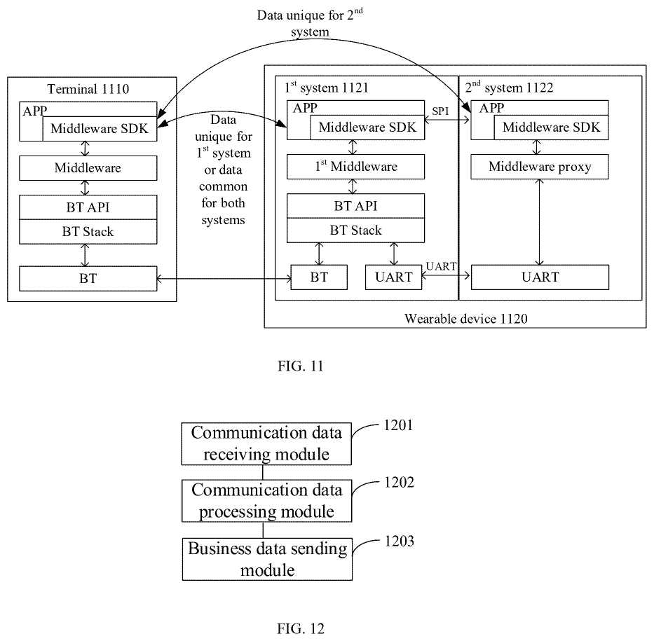

As shown in FIG. 12, FIG. 12 shows a block diagram of a data transmission apparatus according to an embodiment of the present disclosure. The apparatus may be achieved, through software, hardware, or a combination of both, as all or a part of the wearable device. The apparatus includes following components.

A communication data receiving module 1201 is configured to receive the first communication data sent by the terminal, and the first communication data are transmitted through the data communication connection established between the first system and the terminal.

A communication data processing module 1202 is configured to process the first communication data through the target middleware to obtain the business data contained in the first communication data. The target middleware is the middleware configured in the first system.

A business data sending module 1203 is configured to send the business data to the target application via the target middleware, and the target application processes the business data, the target application is the application in the first system or the application in the second system.

In some embodiments, the business data sending module 1203 includes following components.

A system determination unit is configured to determine, via the target middleware, the target system configured to process the business data.

A business data sending unit is configured to send the business data to the target application in the target system via the target middleware.

The business data sending unit is specifically configured to perform following operations.

The business data sending unit is specifically configured to

In the case that the target system being the first system, the target middleware sends the business data to the target application in the first system.

In the case that the target system being the second system, the target middleware sends the business data to the middleware proxy in the second system; the middleware proxy sends the business data to the target application in the second system.

In some embodiments, the apparatus further includes following components.

A waking up module is configured to switch the second processor from the dormant state to the wake-up state in a case that the first system is in the foreground operating state and the second system is in the dormant state. The second system is in the foreground operating state when the second processor is in the wake-up state.

In some embodiments, the business data sending unit is further configured to perform following operations.

The business data sending unit is further configured to send the business data via the target middleware to the target application in the target system in the foreground operating state, in a case that the target system is the first system or the second system.

In some embodiments, the business data sending unit is specifically configured to perform following operations:

The business data sending unit is specifically configured to send, via the target middleware, the business data to the target application in the first system in the foreground operating state in a case that the first system is in the foreground operating state.

The business data sending unit is specifically configured to send, via the target middleware, the business data to the middleware proxy in the second system in a case that the second system is in the foreground operating state; send, via the middleware proxy, the business data to the target application in the second system.

In some embodiments, the apparatus further includes following components.

A response data processing module is configured to process, through the target middleware, the business response data of the target application to obtain the second communication data.

A communication data sending module is configured to send the second communication data to the terminal, such that the terminal processes the business response data. The second communication data are sent through the data communication connection.

In some embodiments, the response data processing module is configured to perform following operations.

The response data processing module is configured to obtain the business response data through the middleware proxy in the second system in a case that the target application is the application in the second system.

The response data processing module is configured to send the business response data to the target middleware through the middleware proxy.

The response data processing module is configured to process the business response data through the target middleware to obtain the second communication data.

In some embodiments, the data communication connection is the Bluetooth connection and the first processor communicates with the Bluetooth communication assembly via the physical serial port.

In some embodiments, the power consumption of the second processor is higher than the power consumption of the first processor.

In summary, in the present disclosure, the wearable device is configured with dual processors, and the first system is run by the first processor, and the second system is run by the second processor. When the first system receives the communication data sent by the terminal through the data communication connection established between the first system and the terminal, the communication data are processed by the middleware configured in the first system to obtain the business data contained in the communication data. The middleware sends the business data to the application in the first system or the application in the second system for business processing. Since the wearable device maintains the data communication with the terminal through the first system, an influence caused by system switching on the data communication can be avoided to ensure stability of the data communication between the wearable device and the terminal. The middleware configured in the first system performs the data processing and distributes the data, such that it is ensured that the business in both the first system and the second system can be processed in time, and the business responding speed on the wearable device is improved.

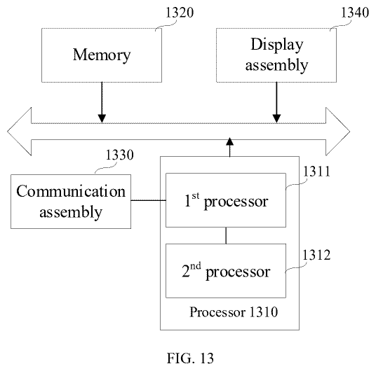

As shown in FIG. 13, FIG. 13 shows a block diagram of the wearable device according to an embodiment of the present disclosure. The wearable device of the present disclosure may include one or more of the following components: a processor 1310 and a memory 1320.

The processor 1310 includes at least the first processor 1311 and the second processor 1312. The first processor 1311 is configured to run the first system and the second processor 1312 is configured to run the second system. The power consumption of the first processor 1311 is lower than the power consumption of the second processor 1312. The performance of the first processor 1311 is lower than the performance of the second processor 1312. The processor 1310 is connected, via various interfaces and wires, to various portions in the entire electronic device to perform various functions of the electronic device and process data by running or executing instructions, programs, code sets, or instruction sets stored in the memory 1320 and by invoking data stored in the memory 1320. In some embodiments, the processor 1310 may be achieved by at least one hardware of: a digital signal processing (DSP), a field-programmable gate array (FPGA), and a programmable logic array (PLA). The processor 1310 may be one or a combination of: a central processing unit (CPU), a graphics processing unit (GPU), a neural-network processing unit (NPU), and a modem. The CPU substantially processes the operating system, user interfaces and application programs, and so on. The GPU is configured to render and draw contents to be displayed on a touch screen. The NPU is configured to achieve artificial intelligence (AI) functions. The modem is configured to perform wireless communication. Understandably, the modem may alternatively be implemented through a separated chip without being integrated into the processor 1310.

The memory 1320 may include a random access memory (RAM) or a read-only memory (ROM). In some embodiments, the memory 1320 includes a non-transitory computer-readable storage medium. The memory 1320 is configured to store instructions, programs, code, code sets, or instruction sets. The memory 1320 may include a storage program area and a storage data area. The storage program area may store instructions for implementing the operating system, instructions for at least one function (such as a touch function, a sound playing function, an image displaying function, and so on), instructions for implementing each of the method embodiments described in the above, and so on. The storage data area may store data created when the wearable device is being in use (such as audio data, contact list), and so on.

The wearable device in the present disclosure further includes a communication assembly 1330 and a display assembly 1340. The communication assembly 1330 may be a Bluetooth assembly, an Ultra Wide Band (UWB) assembly, and so on, and may be configured communicate with an external device via a wired or wireless network. The display assembly 1340 is configured to display a graphical user interface and/or to receive user interaction operations.

In the present disclosure, the first processor 1311 and the communication assembly 1330 are connected via the physical serial port. That is, in the case that the first system is in the operating state, the first system may maintain data communication connection with other devices to perform data communication via the data communication connection.

In addition, it is understood by any ordinary skilled person in the art that the structure of the wearable device illustrated in the above-described accompanying drawings does not constitute a limitation of the wearable device, and the wearable device may include more or fewer components than illustrated or include a combination of certain components, or have a different arrangement of the components. For example, the wearable device further includes an RF circuit, an input unit, a sensor, an audio circuit, a speaker, a microphone, a power supply, and other components, which will not be described herein.

The present disclosure further provides a computer-readable storage medium storing at least one instruction. The at least one instruction is used to be executed by a processor to perform the data transmission method as described in the above embodiments.

The present disclosure further provides a computer program product, the computer program product includes computer instructions, the computer instructions are stored in the computer-readable storage medium. A processor of the computer device reads the computer instructions from the computer-readable storage medium, and the processor executes the computer instructions such that the computer device performs the data transmission method provided by the above embodiments.

It should be understood by any ordinary skilled person in the art that, in one or more of the above examples, the functions described in the embodiments of the present disclosure may be implemented using hardware, software, firmware, or any combination thereof. When implemented using software, the functions may be stored in a computer-readable medium or transmitted as one or more instructions or codes on a computer-readable medium. The computer-readable medium includes a computer storage medium and a communication medium. The communication medium includes any medium that facilitates transmission of a computer program from one location to another. The storage medium may be any available medium to which a general purpose or specialized computer has access.

The above description shows only embodiments of the present disclosure and is not intended to limit the present disclosure. Any modification, equivalent substitution, improvement, and so on, made within the spirit and principles of the present disclosure shall be included in the scope of the present disclosure.

1. A data transmission method, performed by a wearable device, wherein the wearable device comprises a first processer and a second processer, the first processor is configured to run a first system the second processor is configured to run a second system; wherein the method comprises:
receiving first communication data sent by a terminal, wherein the first communication data are transmitted through data communication connection established between the first system and the terminal;
processing the first communication data through a target middleware to obtain business data contained in the first communication data, wherein the target middleware is a middleware configured in the first system; and
sending the business data to a target application via the target middleware; processing, by the target application, the business data, wherein the target application is an application in the first system or an application in the second system.

2. The data transmission method according to claim 1, wherein the sending the business data to a target application via the target middleware, comprises:
determining, via the target middleware, a target system configured to process the business data; and
sending the business data to the target application in the target system via the target middleware.

3. The data transmission method according to claim 2, wherein the sending the business data to the target application in the target system via the target middleware, comprises:
in a case that the target system is the first system, sending, via the target middleware, the business data to the target application in the first system; and
in a case that the target system is the second system, sending, via the target middleware, the business data to a middleware proxy in the second system; sending, via the middleware proxy, the business data to the target application in the second system.

4. The data transmission method according to claim 3, wherein, before the in a case that the target system is the second system, sending, via the target middleware, the business data to a middleware proxy in the second system, the method further comprises:
switching the second processor from a dormant state to a wake-up state in a case that the first system is in a foreground operating state and the second system is in a dormant state.

5. The data transmission method according to claim 2, wherein the sending the business data to the target application in the target system via the target middleware, further comprises:
sending, via the target middleware, the business data to the target application in the target system in a foreground operating state, in a case that the target system is the first system or the second system.

6. The data transmission method according to claim 5, wherein the sending, via the target middleware, the business data to the target application in the target system in a foreground operating state, comprises:
sending, via the target middleware, the business data to the target application in the first system in a case that the first system is in the foreground operating state; and
sending, via the target middleware, the business data to the middleware proxy in the second system in a case that the second system is in the foreground operating state; sending, via the middleware proxy, the business data to the target application in the second system.

7. The data transmission method according to claim 1, wherein, after the sending the business data to a target application via the target middleware, the method further comprises:
processing, by the target middleware, business response data of the target application to obtain second communication data; and
sending the second communication data to the terminal, wherein the terminal is capable of processing the business response data; and the second communication data are sent through the data communication connection.

8. The data transmission method according to claim 7, wherein the processing, by the target middleware, business response data of the target application to obtain second communication data, comprises:
obtaining, via the middleware proxy in the second system, the business response data in a case that the target application is the application in the second system;
sending, via the middleware proxy, the business response data to the target middleware; and
processing, by the target middleware, the business response data to obtain the second communication data.

9. The data transmission method according to claim 1, wherein the data communication connection is Bluetooth connection, and the first processor communicates with a Bluetooth communication assembly via a physical serial port.

10. The data transmission method according to claim 1, wherein power consumption of the second processor is higher than power consumption of the first processor.

11-20. (canceled)

21. A wearable device, comprising a processor and a memory; wherein the processor comprises at least a first processor and a second processor, the memory stores at least one instruction, the at least one instruction is configured to be executed by the processor to implement operations of:
receiving first communication data sent by a terminal, wherein the first communication data are transmitted through data communication connection established between the first system and the terminal;
processing the first communication data through a target middleware to obtain business data contained in the first communication data, wherein the target middleware is a middleware configured in the first system; and
sending the business data to a target application via the target middleware; processing, by the target application, the business data, wherein the target application is an application in the first system or an application in the second system.

22. A computer-readable storage medium, storing at least one instruction, wherein the at least one instruction is configured to be executed by a processor to implement operations of:
receiving first communication data sent by a terminal, wherein the first communication data are transmitted through data communication connection established between the first system and the terminal;
processing the first communication data through a target middleware to obtain business data contained in the first communication data, wherein the target middleware is a middleware configured in the first system; and
sending the business data to a target application via the target middleware; processing, by the target application, the business data, wherein the target application is an application in the first system or an application in the second system.

23. (canceled)

24. The wearable device according to claim 21, wherein the sending the business data to a target application via the target middleware, comprises:
determining, via the target middleware, a target system configured to process the business data; and
sending the business data to the target application in the target system via the target middleware.

25. The wearable device according to claim 24, wherein the sending the business data to the target application in the target system via the target middleware, comprises:
in a case that the target system is the first system, sending, via the target middleware, the business data to the target application in the first system; and
in a case that the target system is the second system, sending, via the target middleware, the business data to a middleware proxy in the second system; sending, via the middleware proxy, the business data to the target application in the second system.

26. The wearable device according to claim 25, wherein, before the in a case that the target system is the second system, sending, via the target middleware, the business data to a middleware proxy in the second system, the method further comprises:
switching the second processor from a dormant state to a wake-up state in a case that the first system is in a foreground operating state and the second system being in a dormant state.

27. The wearable device according to claim 24, wherein the sending the business data to the target application in the target system via the target middleware, further comprises:
sending, via the target middleware, the business data to the target application in the target system in a foreground operating state, in a case that the target system is the first system or the second system.

28. The wearable device according to claim 27, wherein the sending, via the target middleware, the business data to the target application in the target system in a foreground operating state, comprises:
sending, via the target middleware, the business data to the target application in the first system in a case that the first system is in the foreground operating state; and
sending, via the target middleware, the business data to the middleware proxy in the second system in a case that the second system is in the foreground operating state; sending, via the middleware proxy, the business data to the target application in the second system.

29. The wearable device according to claim 21, wherein, after the sending the business data to a target application via the target middleware, the method further comprises:
processing, by the target middleware, business response data of the target application to obtain second communication data; and
sending the second communication data to the terminal, wherein the terminal is capable of processing the business response data; and the second communication data are sent through the data communication connection.

30. The wearable device according to claim 29, wherein the processing, by the target middleware, business response data of the target application to obtain second communication data, comprises:
obtaining, via the middleware proxy in the second system, the business response data in a case that the target application is the application in the second system;
sending, via the middleware proxy, the business response data to the target middleware; and
processing, by the target middleware, the business response data to obtain the second communication data.

31. The data transmission method according to claim 1, wherein the second system is configured with a middleware proxy corresponding to the target middleware in the first system; the middleware proxy serves as a data communication medium between the target middleware and the application in the second system.
